(19) United States
(12) Patent Application Publication
(10) Pub. No.: US 2009/0158530 A1
(43) Pub. Date: Jun. 25, 2009

(54) USE OF CHROMIUM COMPLEX IN THE LEATHER INDUSTRY

(75) Inventors: Tarik Erdal, Istanbul (TR); Asim Onculer, Istanbul (TR)

Correspondence Address: COLLEN IP, THE HOLYOKE MANHATTAN BUILDING, 80 SOUTH HIGHLAND AVENUE, OSSINING, NY, 10562, US

(73) Assignee: SODA SANAYI A.S., Istanbul (TR)

(21) Appl. No.: 12/206,205

(22) Filed: Sep. 8, 2008

(30) Foreign Application Priority Data
Dec. 25, 2007 (TR) TR2007/08916

(51) Int. Cl. C14C 3/06; C14C 3/28

(52) U.S. Cl. 8/94.27

(57) ABSTRACT

This invention is related to the manufacturing process of the modified chromium sulphate used in the tanning process of the animal hides, and chromium tanning process performed by using the said chemical.

This invention develops
Manufacturing processes of chromium tanning chemical which do not require pickling and basification;
Chromium and tanning chemical produced according to this process; and
Chromium tanning processes which use the said chemical and do not require pickling and basification.

As a result of the reaction of the chromium salts mentioned in the invention with mono and dicarboxyllic acids or salts of these acids, characteristics of the chromium salts change; thereby the invention provides benefits such as the elimination of the pickling and the basification process, minimization of the waste treatment burden and acceleration of the said processes in the tannery.

### FIELD OF INVENTION

This invention is related with the chromium sulphate manufacturing process used to tan hides and skins, and chromium tanning process performed by using the said chemical.

### PRIOR ART

In the world, 90% of the hides and skins are tanned by chromium (III) salts. Chromium (III) salts are obtained by passing sulphur dioxide through sodium bichromate solution. They are also produced by means of the reduction of the sodium bichromate by sugar in sulphuric acid environment. This invention is related to the manufacturing of chromium(III) tanning chemical showing different features in terms of tanning with respect to basic chromium sulphate.

The used chromium chemicals are collectively named as “basic chromium sulphate” and basic chromium sulphate products are classified according to their % of basicity. In general, three types of chromium sulphate chemicals having basicity of 33%, 42% and 50% are used in the tanning processes in the world. While the products having basicity of 33% and 42% are applied in main chromium tannage and retannage, the products having basicity of 50% are usually preferred in retannage. The term of basicity at % refers to the amount of hydroxide within basic chromium sulphate. For instance, in basic chromium sulphate having basicity of 33%, one hydroxide is allocated for each chromium and it is simply shown with the formula of Cr₂(OH)₂(SO₄)₃Na₂. Each chromium is corresponded with 1.25 hydroxide in a product having basicity of 42%. While the amount of hydroxide affiliated to chromium increases, the tendency of the chromium to react with the carboxylic acid groups of the hide increases and its tendency of penetration into the hide decreases (E. Heidemann (1993), Fundamental of Leather Manufacturing).

Chromium in the basic chromium sulphate used in hide tanning both connects functional carboxyl groups of the proteins in fiber structure to each other by using its capacity of 6 coordinative bonds and constitutes infrastructure for the chemicals such as other synthetics and vegetable tannins, fatliquor and dye stuff which are used later by means of its positive charge. Therefore, it is possible to manufacture leathers bearing the physical and chemical characteristics requested (E. Heidemann (1993), Fundamental of Leather Manufacturing, Darmstadt).

Prior to the chromium process performed by using the existing basic chromium sulphate products, pickling process is undertaken in order to be prepared for the chromium process. During the pickling process of the hide treatment, approximately 8% of salt, 0.5% of formic acid and 1% sulphuric acid are used depending on the pelt weight of the hide. The used salts prevent the swelling of the hide in the acidic environment and ensure that the hide fibers are not harmed. In the literature, there are available studies and products where naphthalene sulphonate is used to minimize or eliminate the use of salt without causing the acid swelling (Leather, 53, April, 1999), (U.S. Pat. No. 7,118,603).

The used acids make the pickling process suitable for the use of basic chromium sulphate. Thus, it enables the used chromium not to precipitate in acidic environment (pH:2.8-3.0) and to penetrate into the leather. Following the penetration of the chromium into the hide, basification process is realized through an alkali material such as magnesium oxide or soda. The purpose for the realization of the basification process is to fix the chromium to the leather (Leather, 77, April, 1996).

According to the study of UNIDO, only 49% of the chromium can be utilized in the worldwide depending on the chromium process. The remaining amount is the wastes discharged as chromium waste liquor, leather trimmings, shaving wastes (Chromium Management in the Tanyard (2000), United Nations Industrial Development Organization). Hence, serious difficulties are encountered in the purification of waste water in addition to the fact that the basic chromium sulphate can not be effectively used.

Hides such as cattle are used to produce upholstery leather, shoe and clothing; and sheepskin, goatskin and pigskin are used for the manufacturing of the leathers for clothing and shoes. In addition, leathers having been processed differently are made of sheepskin which maintains the wool on their top.
Manufacturing of leather from cattle, goat, sheep are alike in terms of the manufacturing process and the equipment employed in this process and particularly have the following similar characteristics. There may be some differences in application depending on the type of raw hide, hide thickness and expectations.
   In the current hide treatment technology,
Raw hide pass through respectively soaking, liming, unhairing, deliming and bating processes.
As a preparation for the chromium main tannage, pickling process is applied to the bated hides, by using approximately 60% water, 6-8% salt, 1% formic acid and 1% sulphuric acid based on the weight (pelt weight). pH value is achieved around 2.8-3.0.
Following the pickling process, pH is at an interval of 2.8-3.0. As 5-8% of basic chromium sulphate over its pelt weight is added into the tanning drum for the purpose of chromium tannage, it is controlled whether the chromium has effectively penetrated into the cross-section or not. This process is completed in 1-3 hours depending on the thickness of hide. Due to the thinness of the skins, both pickling process and penetration of chromium is completed in a relatively shorter period.

Following this phase, pH value is increased upto an interval of 3.6-3.8 gradually. Therefore, the chromium starts to fix to the fiber of the hide. 0.5% low-reactivated magnesium oxide or 2% sodium bicarbonate or soda may be used in the basification process.
After basification, the tanning drum runs for 6-8 hours.
Bath is discharged.
Waste liquor containing chromium is transferred to waste treatment or waste recycling unit.

According to the study of UNIDO, chromium efficiency in the tanning process is 49% at average. In other words, existing basic chromium sulphate and tanning process make use of 49% of the chromium. The remaining amount is disposed as leather trimmings, shaving wastes and chromium waste liqour.

Compared to the prior art, chromium sulphate which is developed with this invention does not require pickling and basification process and shortens the chromium tannage duration; eliminates the use of sulphuric acid and magnesium oxide (or sodium bicarbonate) thereby leading to decreasing the burden of waste. Furthermore, high chromium efficiency is achieved in the process developed with this invention.

Treatment of woolly sheepskins differs due to the wool that needs to be protected. In the process of woolly sheepskins, liming and unhairing process are not employed for the purpose of the protection of the wool. Besides, compared to hide processing higher amount of float(large amount of water) is used for the creation of less mechanical impact in order to avoid the wool from matting during the chromium tanning process. Therefore, chromium efficiency in the chromium tannage of wolly sheepskins is relatively lower compared to the treatment of hides, goat and sheep skins. Generally, the following steps are followed in the conventional tanning process of woolly sheepskins:
Pickled wooly sheepskins are waited for at least 3 days,
10 liter of water is used for each skin, pH of the float is adjusted to 6.5-7.0 by applying depickling.
Bating process is realized as a follow up of fleshing and degreasing processes;
10 liter of water is taken for each skin after washing and draining; a new bath is formed and sodium chloride is applied providing 6-7° Be.
20-25 gr basic chromium sulphate is added for each liter. Besides, chromium masking agent, syntans and fatliquors can be used;
pH is adjusted to 3.7-3.9 by means of the basification process realized by using sodium bicarbonate 1-2 hours later;
the chromium process takes 8-10 hours;
The bath is discharged;
Chromium waste liquor is either transferred to waste treatment or chromium recycling unit;
Mechanical processes, retannage, fatliquoring and dying is carried on.

Several studies are available in the literature with an aim to increase the efficiency of chromium and eliminate pickling and basification processes. In U.S. Pat. No. 4,042,321 and U.S. Pat. No. 4,978,361 patents, dicarboxylic acids in powder form are used in mixture with basic chromium sulphate powder to promote the exhaustion of the chromium. U.S. Pat. No. 7,063,728 describes a process where formic, lactic and acetic acids are used in the pickling process. U.S. Pat. No. 7,118,603 uses carboxylic acids in the production of aromatic and acrylic synthetic syntans and states that this product used along with basic chromium sulfate increases the efficiency of the chromium and eliminates the pickling process. In another study (U.S. Pat. No. 4,919,680), basification material in powder form is added to the powder product obtained as a result of the reaction of glutaric, succinic and adipic acids in order to ensure the exhaustion of the chromium. It claims that the developed pickling process increases the efficiency of the chromium. U.S. Pat. No. 3,174,817 and WO 053170 patents, chromium is masked with mono and dicarboxylic acids; and gained with alkaline resistance; and differently WO 053170 patent makes use of NaCl during the pickleless chromium process.

Following the studies conducted within the scope of this invention, for a pickleless process, certain level of alkaline resistance is achieved as a result of masking chromium with organic acids. The said level of alkaline resistance is defined as to resist basicity of 500% for 2 hours when alkaline is added to the solution of invented chromium sulfate, namely not to create any chromium precipitation or turbidity in the chromium solution. This characteristic is of great significance for the chromium tannage. The created alkaline resistance decreases 2 hours after the powder chromium sulphate is dissolved. As a result, extent of chromium fixation increases gradually as the alkaline resistance decreases with time. Thus, physical properties expected from the leather such as softness and flexibility are improved. In the studies under this invention, it is seen that strong acid addition is necessary to impair the chromium-masking at the end of the chromium tannage.

### OBJECTIVES FOR THE DEVELOPMENT OF THE INVENTION

In developing the manufacturing process of the chromium tanning chemical which do not necessitate pickling and basicification; and chromium tanning process with the said chemical which have been developed with this invention, it was aimed;
To increase the efficiency of chromium in the tanning process of hides, goatskins, sheepskins and woolly sheepskins; and to decrease the load of waste treatment of chromium waste liquors.
To decrease the load of waste by eliminating the use of salt, sulphuric acid and basifying agents.
To accelarate the process by removing the pickling and basification process,
To use the basic chromium sulphate at relatively less amounts due to the increase in the chromium efficiency; and to save from the use of chemical with the removal of the use of salt, sulphuric acid and basifying agents.

### DETAILED DESCRIPTION OF THE INVENTION

This invention develops
Manufacturing process of modified chromium sulphate that does not necessitate pickling and basification; and manufacturing process of tanning chemical;
Modified chromium sulphate chemical manufactured according to this process; and
Chromium tanning process which uses the said chemical and does not need pickling and basification process.

Chromium sulphate developed with this invention allows the chromium tannage to begin approximately at 5.0-8.5 pH interval by eliminating the use of salt and sulphuric acid; and does not require the basification process. Prevention of precipitation of the chromium at the said pH values, in contrast its penetration to the hide depends on the decrease of the interest of chromium sulphate having coordinative chemical links with organic acids on the carboxyl groups of the hide. This feature attributed to the chromium sulphate is an essential factor in fulfilling the expectations for the chromium sulphate.

In this scope, chromium complex is established by mono and dicarboxylic organic acids in the content of the chemical that is the subject of this invention. These organic acids are selected among formic acid, acetic acid, propionic acid, gylcolic acid, lactic acid, oxalic acid, fumaric acid, phthalic acid, maleic acid, succinic acid, glutaric acid, adipik acid, malic acid, citric acid, tartaric acid or the group consisting of the salts of these acids or anhydrid form.

When compared to the existing hide tanning treatment process, the manufacturing process of chromium and tanning chemical which do not require pickling and basification developed with this invention and chromium tanning process with this chemical do not only eliminate the use of salt and sulphuric acid but also the basification process which is performed during the chromium process. Thus, chromium tannage takes relatively shorter period of time rather than the current methods used in the tanning process.

The product to be developed as described in the invention may be used in the treatment of hides and skins, provided that it is used as it is disclosed in the invention.

Chromium sulphate product (chemical) that is the subject of the invention and has technical characteristics eliminating pickling and basification stages is produced according to the following steps:
Chromium sulphate or sucrose reduced by inorganic method (by SO₂) or reduced by organic method(by sugar, glucose, melas) (Sharphouse, J. H. (1983) Leather Technician's Handbook p. 185) has a chromium oxide content of 10-18 Cr₂O₃% and a basicity of −(minus) 15% to 38% (Lehigh method, Journal of the Society of Leather Technologists and Chemists, JSLTC, 1954, V.38, No 1, Pg. 102),
Chromium sulphate powder is prepared by adding 0.1-1.0 mol mono or dicarboxylic acids for each mol chromium to the chromium sulphate solution. Alkaline resistance of the said chromium sulphate powder should be 2 hours for the basicity at 500%. In other words, one or more than one mono or dicarboxylic acids at mole interval of 0.1-1.0 for each mole chromium are used to provide the alkaline resistance of the chromium sulphate powder to be obtained 500% for 2 hours. Hence, the modified chromium sulphate powder is acquired from the modified chromium sulfate liquor. Alkaline resistance of the mentioned modified chromium sulphate powder is tested according to the following method.

### Alkaline Resistance Test:

Powder chromium sulphate is weighed to be 0.5 gram of as Cr₂O₃. It is dissolved in 100 ml of distilled water heated upto 25° C. Until the basicity of the solution becomes 500%, 3N Na₂CO₃ heated upto 25° C. is added at a speed of 8 ml/min. under the magnetic mixer. After the completion of the addition, duration starts. It should be observed that the clarity does not change for 2 hours.

Mono and dicarboxylic organic acids used in the manufacturing of the modified chromium sulphate, that is the subject of this invention: formic acid, acetic acid, propionic acid, gylcolic acid, lactic acid, oxalic acid, fumaric acid, phthalic acid, maleic acid, succinic acid, glutaric acid, adipic acid, malic acid, citric acid or salts of these acids and anhydride forms such as phthalic anhydride and maleic anhyride.

Application of the product developed under this invention in the main chromium tannage is considerably changed compared to the process used in the prior art. The said change first of all includes the total elimination of the pickling and the basification processes.

### INDUSTRIAL APPLICABILITY OF THE INVENTION

Chromium tanning process which does not require pickling and basification developed under this invention begins after liming and bating process.

Chromium tanning process developed under this invention is applied to the manufacturing of hides, skins and woolly sheepskins:
pH value of the hide passed through liming and bating processes is at the interval of 8.0-8.5. 50-100% of water based on pelt weight is taken into the tanning drum and the modified chromium sulphate developed with this invention is released into the drum at the proportion of 2-8% depending on the type and thickness of the hide and the skin. Penetration of the modified chromium sulphate developed with this invention is ensured. The penetration period is nearly 2-3 hours. Classical chromium sulphate chemicals (produced according to the prior art) having basicity at 33% may also be added following the penetration if deemed necessary. Chromium process may be performed for 4-8 hours depending on the type and the thickness of the hide. At the end of the main chromium tannage it is aimed to achieve the temperature of the float to be 30-50° C. due to the mechanical impact and the pH value of the bath is at an interval of 3.0-4.2,
The bath is discharged,
Washed by 0.1-0.5% of concentrated sulphuric acid and 50% of water,
Wet-blue leathers are piled,
The remaining processes are carried on as usual.

The application of the main chromium tannage process developed with this invention in the manufacturing of the woolly sheepskin is as follows:
Pickled woolly sheepskin are waited for at least 3 days,
10 liter of water is transferred for each woolly skin, bath pH is adjusted to 6.5-7.0 by the application of depickling.
Bating process is realized as a follow up of fleshing and degreasing processes;
10 liter of water is taken for each skin after washing and draining, a new bath is formed and sodium chloride is not applied;
15 to 20 gr of the product developed with this invention are added for each liter of float. Besides, syntans and fatliquors may be added;
Basification process is not applied. pH is automatically at 3.2-3.8 interval.
Chromium tannage takes 2-6 hours;
The bath is discharged;
They are washed by 0.1-0.5% of concentrated sulphuric acid and 50% of water;
The waste liquor of chromium tannage is either transferred to waste treatment or chromium recycling unit;
Mechanical processes, retannage, fatliquoring and dying are carried on as usual.

### EXAMPLE 1

1000 kg of hide for which liming, unhairing and fleshing processes are completed is washed in the tanning drum (diameter: 2 meters, width: 2.25 m and 10-12 rpm) by 150% of water (based on the pelt weight) and water at 35-38° C. for 10 minutes for the manufacturing of shoe upper.

After the washing water is discharged, hides are subjected to deliming by 3% of NH₄Cl and 0.5% of sodium bisulphite after taking in water at 70% at 32° C. temperature. After all, bating process takes place, adding 0.7% standard enzymatic bating material for 30 minutes (pH:8.0). At this stage, the cross-section of the hide should not reveal pink color with phenolphtalein indicator. The hides are rinsed by water at a temperature of 18° C. for 10 minutes.

50% of water at a temperature of 20-25° C. and 5-7% of chromium sulphate described under the invention are added into the drum, and it is run under these conditions for 5-8 hours. At the end of the chromium tannage the temperature is around 35-40° C. and pH value is at the interval of 3.2-3.8.

Modified chromium sulfate of this invention is prepared as follows: 963 unit (including 10-18% of Cr₂O₃) and preferably 12% of Cr₂O₃ together with 37 unit of maleic anhydride are mixed as dissolved in water. Basicity value of the aqueous solution of chromium may shift between − (minus) 15% and 33%. After the chromium sulphate solution turns into powder form, it should be resistant to basicity at 500% for 2 hours.

The following organic acids may also be used in the said manufacturing process in order to eliminate pickling and basification processes in the manufacture of shoe upper.

Formic acid, acetic acid, propionic acid, gylcolic acid, lactic acid, oxalic acid, fumaric acid, phthalic acid, maleic acid, succinic acid, glutaric acid, adipic acid, malic acid, citric acid or salts of these acids and anhydride forms such as phthalic anhydride and maleic anhyride.

### EXAMPLE 2

1000 kg of hide for which liming and unhairing processes are completed is treated as in Design 1 and brought to the main chromium tanning process. Chromium sulfate of 5-7% is provided according to the pelt weight and it is carried on as in Design 1.

955 unit (including 10-18% of Cr₂O₃) and preferably 12% of Cr₂O₃ together with 45 unit of acetic acid are mixed together. Basicity value of the aqueous solution of chromium sulfate may shift between − (minus) 10% and 33%. After the liquid chromium sulphate turns into powder form, it should be resistant to basicity at 500% for 2 hours.

### EXAMPLE 3

1000 kg of goatskin for which unhairing, liming, fleshing and bating processes are completed is washed by 150% of water (based on pelt weight) for the manufacturing of shoe and lining leather from goatskin.

After the washing water is drained off, pelts are subjected to deliming by 3% of NH₄Cl and 0,5% of sodium bisulphite for 35 minutes after taking in 50-70% water at 32° C. temperature. After all, bating process is undertaken with 0.7% standard enzymatic bating material for 30 minutes (pH:8,0). At this stage, the cross-section of the pelt should not reveal pink color with phenolphtalein indicator. The pelts are rinsed by water at a temperature of 18° C. for 10 minutes.

50% of water at a temperature of 20-25° C. and 5-7% of chromium sulphate described under the invention are added into the drum as in Design 1, and it is run under these conditions for 4-8 hours. At the end of the chromium tannage, the temperature is around 35-40° C. and pH value is at the interval of 3.2-3.8. The latter steps are carried on as usual.

### EXAMPLE 4

The application of chromium sulphate tanning chemical developed with this invention in the manufacturing of the woolly sheepskin is as follows:
Pickled woolly sheepskins are waited for at least 3 days,
10 liter of water is taken for each skin, depickling is carried out and bath pH is adjusted to 6.5-7.0,
Bating process is realized as a follow up of fleshing and degreasing processes;
10 liter of water is taken for each skin after washing and draining; a new bath is formed.
15-20 gr of the product developed with this invention is added for each liter of float. Besides, masking agents, syntans and fatliquors may be added;
Basification process is not realized. pH is automatically at 3.2-3.8 interval.
Chromium tannage takes 2-6 hours;
The bath is drained off;
The leather is washed by 50% of water and 0.1-0.5% of concentrated sulphuric acid.
The waste liquor of chromium tannage is either transferred to waste treatment or chromium recycling unit;
Mechanical processes, retannage, fatliquoring and dying are carried on.

### REFERENCES

E. Heidemann (1993), Fundamental of Leather Manufacturing
A. Marsal, A, Rius et al. JSLTC vol. 89, p. 232
Peter M. Pojer, Chi P. Huynh, Leather, 53, April, 1999
V. Chagne, F. Silvestre, Leather, 77, April, 1996
Chromium Management in the Tanyard (2000), United Nations Industrial Development Organization
Sharphouse, J. H. (1983) Leather Technician's Handbook p. 185

1- Manufacturing process of chromium tanning chemical which does not require pickling and basification processes and modified chromium sulphate in liquid or powder form manufactured based on this process, are characterized with the following processes:
a Chromium sulphate liquor used in the manufacture of the modified chromium sulfate is obtained by inorganically or organically reduced methods. The chromium sulfate liquor has a basicity − (minus) 15% and 38% and a chromium oxide content of 10-18 Cr₂O₃%. The modified chromium sulfate is prepared by using mono or dicarboxylic acids at mole interval of 0.1-1.0 for each mole chromium in a way that the alkaline resistance of modified chromium sulphate in powder form to be resistant to 500% of basicity for 2 hours;
Modified chromium sulphate powder is weighed as to be 0.5 gram of Cr₂O₃; dissolved in 100 ml of distilled water heated upto 25° C.; 3N Na₂CO₃ heated upto 25° C. is added at a speed of 8 ml/min. under the magnetic mixer, until the basicity of the precipitation becomes 500%; duration starts after the completion of the addition process, and the stages of the observation that the clarity does not change for 2 hours are tested.

2- Manufacturing process of chromium tanning chemical which does not require pickling and basification processes and modified chromium sulphate in liquid or powder form manufactured based on this process according to claim 1, characterized in that mono and dicarboxylic organic acids are comprised by formic acid, acetic acid, propionic acid, gylcolic acid, lactic acid, oxalic acid, fumaric acid, tartaric acid, phthalic acid, maleic acid, succinic acid, glutaric acid, adipic acid, malic acid, citric acid or salts of these acids and anhydride forms such as phthalic anhydride and maleic anhyride.

3- Chromium tanning processes which do not require pickling and basification are characterized with the following steps of application for the manufacturing of leathers from hides, skins and woolly sheepskins.
Water is added into the tanning drum at a proportion of 50-100% according to the pelt weight processed through liming and bating process and having pH value at an interval of 8.0-8.5 and addition of modified chromium sulphate powder as described in claim 1 or claim 2 at a proportion of 2-8% depending on type and thickness of the hide; penetration of the chromium is allowed for 2-3 hours;
chromium process may be performed for 4-8 hours depending on type and thickness of the hide; and as a result of the chromium process, it is ensured that the temperature of the float in the drum is around 30-50° C. due to the mechanical impact and pH value of the float is at an interval of 3,0-4,2;
The float is drained off and washed by 0.1-0.5% of concentrated sulphuric acid and 50% of water;
Wet-blue leathers are piled.

4- Chromium tanning processes which do not require pickling and basification according to the claim 3 and characterized in that chromium sulphate chemicals having basicity of 33% and produced according to the prior art are added following the penetration process.

5- Chromium tanning processes which do not require pickling and basification to be used in the woolly sheepskin manufacturing and characterized with the following steps:
Pickled skins are waited for at least 3 days,
10 liters of water are transferred to the tanning mixer for each skin and float pH is adjusted to 6.5-7.0.
Bating process is realized as a follow up of fleshing and degreasing processes;
10 liter of water is taken for each skin for washing; a new bath is formed and sodium chloride is not applied;
15-20 gr of modified chromium sulphate powder as described in claim 1 and claim 2 is added for each liter of float.
Basification process is not realized. pH is automatically at an interval of 3.2-3.8.
Chromium process is carried on for 2-6 hours;
The bath is drained off and washed by 0.1-0.5% of concentrated sulphuric acid and 50% of water;
The waste liquor is either transferred to waste treatment or chromium recycling unit.

6- Chromium tanning processes which do not require pickling and basification according to the claim 5 and characterized in that while adding 15-20 gram of modified chromium sulphate powder as described in claim 1 and claim 2 in apiece liter, syntans and factiquors may also be added.
